(19) United States
(12) Patent Application Publication
(10) Pub. No.: US 2025/0382512 A1
(43) Pub. Date: Dec. 18, 2025

(54) COMPOSITION AND SOLUTION FOR TEMPORARY BONDING AGENT

(71) Applicant: Taichem Materials Co., Ltd., KAOHSIUNG CITY (TW)

(72) Inventors: Ming-Xue WEI, KAOHSIUNG CITY (TW); Jing-Ping WANG, KAOHSIUNG CITY (TW); Po-Wen LIN, KAOHSIUNG CITY (TW)

(21) Appl. No.: 19/235,623

(22) Filed: Jun. 12, 2025

(30) Foreign Application Priority Data
Jun. 14, 2024 (TW) 113122118

(51) Int. Cl. C09J 175/06; C09J 5/00

(52) U.S. Cl. CPC C09J 175/06; C09J 5/00

(57) ABSTRACT

A temporary bonding agent composition and a temporary bonding agent solution are provided. The temporary bonding agent composition includes the main resin and the hydrocarbon-based polymer resins. The main resin includes at least one resin selected from a group consisting of an epoxy resin, an alkyd resin, a phenol formaldehyde resin, a polyurethane resin and a polyester polyol resin. At least one of the hydrocarbon-based polymer resins has a functional group able to react with the main resin to form a polyurethane linkage. Based on an amount of the temporary bonding agent composition as 100 wt %, the main resin is 20 wt % to 35 wt %, and the at least one of the hydrocarbon-based polymer resin is 15 wt % to 30 wt %. A temporary bonding layer formed from the temporary bonding agent composition can have great rigidity.

### CROSS-REFERENCE TO RELATED APPLICATION

This application claims priority to Taiwan Application Serial Number 113122118, filed Jun. 14, 2024, which is herein incorporated by reference.

### BACKGROUND

### Field of Invention

The present invention relates to a temporary bonding agent composition and a temporary bonding agent solution. More particularly, the present invention relates to the temporary bonding agent composition and the temporary bonding agent solution for forming a temporary bonding layer with great rigidity.

### Description of Related Art

In a semiconductor process, temporary bonding is a critical step in late stage of wafer fabrication. The temporary bonding is used to bond the obtained wafer to a carrier, thereby performing the following operations such as thinning, testing and packaging. The wafer and the carrier are separated from each other after the above operations are completed.

However, when conventional temporary bonding adhesive is used in the thinning operation, wafer warpage may occur due to generation of stress, resulting in problems such as grain slip. In addition, if the conventional temporary bonding adhesive cannot resist process operations, a dielectric layer (polyimide, for example), which is laminated on a protective layer, is prone to moisture absorption and gas generation, resulting in a problem of popcorn.

Therefore, it is needed to provide a temporary bonding agent composition with great rigidity, thus solving the problems of grain slip and popcorn.

### SUMMARY

An aspect of the present invention provides a temporary bonding agent composition, which includes specific amount of a main resin and hydrocarbon-based polymer resins, and a temporary bonding layer with great rigidity formed by the temporary bonding agent composition can avoid problems of grain slip and popcorn.

Another aspect of the present invention provides a temporary bonding agent solution, which includes the temporary bonding agent composition of the above aspect.

According to the aspect of the present invention, the temporary bonding agent composition is provided, which includes the main resin and the hydrocarbon-based polymer resins. The main resin includes at least one resin selected from a group consisting of an epoxy resin, an alkyd resin, a phenol formaldehyde resin, a polyurethane resin and a polyester polyol resin. At least one of the hydrocarbon-based polymer resins has a functional group able to react with the main resin to form a polyurethane linkage. Based on an amount of the temporary bonding agent composition as 100 wt %, the amount of the main resin is 20 wt % to 35 wt %, and the amount of the at least one of the hydrocarbon-based polymer resins is 15 wt % to 30 wt %.

According to an embodiment of the present invention, when the main resin is the polyester polyol resin, the polyester polyol resin has a molecular weight in a range between 5000 and 50000.

According to an embodiment of the present invention, the temporary bonding agent composition further includes a solvent, in which the solvent includes at least one of N-methylpyrrolidone, methyl ethyl ketone, dibasic ester and cyclohexanone.

According to an embodiment of the present invention, the functional group is either a cyanate group or an isocyanate group.

According to an embodiment of the present invention, the temporary bonding agent composition has a heat resistance temperature in a range from 350° C. to 405° C.

According to an embodiment of the present invention, the temporary bonding agent composition has a complex viscosity less than 1000 Pas at a temperature of 100°° C. to 160° C.

According to an embodiment of the present invention, the temporary bonding agent composition has a storage modulus in a range from 5 MPa to 50.5 MPa at 200° C. after the temporary bonding agent composition is heated at a temperature of 50° C. to 300° C. for over 10 minutes.

According to an embodiment of the present invention, the temporary bonding agent composition can be dissolved in a basic solution, and the basic solution includes at least one of tetramethylammonium hydroxide, tetraethylammonium hydroxide and ethanolamine.

According to an embodiment of the present invention, a cleaning rate of the temporary bonding agent composition at a temperature of 60° C. is in a range between 2 μm/min and 7.5 μm/min by using the basic solution.

According to another aspect of the present invention, a temporary bonding agent solution is provided, which includes the above temporary bonding agent composition.

According to the aspect of the present invention, providing the temporary bonding agent composition, which includes the main resin and the hydrocarbon-based polymer resins. The main resin includes at least one resin selected from a group consisting of an epoxy resin, an alkyd resin, a phenol formaldehyde resin, a polyurethane resin and a polyester polyol resin. At least one of the hydrocarbon-based polymer resins has a cyanate group or an isocyanate group. A ratio of an amount of the main resin to an amount of the at least one of the hydrocarbon-based polymer resins is 0.67 to 2.33.

According to an embodiment of the present invention, based on an amount of the temporary bonding agent composition as 100 wt %, the amount of the main resin is 20 wt % to 35 wt %, and the amount of the at least one of the hydrocarbon-based polymer resins is 15 wt % to 30 wt %.

According to an embodiment of the present invention, the main resin is the polyester polyol resin.

According to an embodiment of the present invention, the polyester polyol resin has a molecular weight in a range between 5000 and 50000.

According to an embodiment of the present invention, the temporary bonding agent composition further includes a solvent, wherein the solvent is a mixing solvent including dibasic ester and at least one of solvent selected from a group consisting of N-methylpyrrolidone, methyl ethyl ketone and cyclohexanone.

According to an embodiment of the present invention, the temporary bonding agent composition has a colloidal viscosity in a range between 2300 cps and 7000 cps.

The temporary bonding agent composition and the temporary bonding agent solution of the present disclosure are applied, and the temporary bonding layer with great rigidity formed by the temporary bonding agent, which is obtained by the specific amount of the main resin and the hydrocarbon-based polymer resins, can avoid problems of grain slip and popcorn. Further, the temporary bonding layer can be removed under basic condition and has great gap-filling ability.

These and other features, aspects, and advantages of the present invention will become better understood with reference to the following description and appended claims.

It is to be understood that both the foregoing general description and the following detailed description are by examples, and are intended to provide further explanation of the invention as claimed.

### DETAILED DESCRIPTION

As used herein, “around,” “about,” “approximately,” or “substantially” shall generally mean within 20 percent, or within 10 percent, or within 5 percent of a given value or range.

The term “rigidity” used herein refers to resistance to deformation of a film layer (e.g. temporary bonding layer), which can be evaluated by the storage modulus.

The term “gap-filling ability” used herein refers to ability of a temporary bonding agent flowing onto the height difference structure of the wafer during application, which can be determined by the complex viscosity under process temperature.

As described above, the present disclosure provides a temporary bonding agent composition and a temporary bonding agent solution, and a temporary bonding layer with great rigidity formed by the temporary bonding agent. The temporary bonding layer obtained by the specific amount of a main resin and hydrocarbon-based polymer resins, can avoid problems of grain slip and popcorn. Further, the temporary bonding layer can be removed by the basic solution and has great gap-filling ability.

The temporary bonding agent composition of the present disclosure includes the main resin and the hydrocarbon-based polymer resins. In some embodiments, at least one of the hydrocarbon-based polymer resins includes a functional group able to react with hydroxyl groups of the main resin to form a polyurethane linkage. In some embodiments, based on an amount of the temporary bonding agent composition as 100 wt %, an amount of the main resin is about 20 wt % to about 35 wt %, an amount of the at least one of the hydrocarbon-based polymer resins is about 15 wt % to about 30 wt %, and the rest includes solvent. In some embodiments, the amount of the main resin is at least 0.67 times the amount of the at least one of the hydrocarbon-based polymer resins, and at most 2.33 times the amount of the at least one of the hydrocarbon-based polymer resins. Such mixing ratio enables the temporary bonding layer formed by the temporary bonding agent composition to have greater rigidity.

If the amount of the main resin is too low (for example, less than 20 wt %), the complex viscosity of the temporary bonding agent composition would be too high (such as greater than 1000 Pa·s), thereby resulting in bad gap-filling ability. On the contrary, if the amount of the main resin is too much (for example, more than 35 wt %), the colloidal viscosity of the temporary bonding agent composition would be too high (for example, greater than 7000 cps), thereby affecting film property (such as flatness) of the formed temporary bonding layer after coating. In addition, if the amount of the at least one of the hydrocarbon-based polymer resins is too low (for example, less than 15 wt %), the rigidity of the temporary bonding layer formed by the temporary bonding agent composition is insufficient and prone to grain slip and popcorn problems during application, and the temporary bonding agent composition is unable to form a linkage structure that reacts easily with the basic solution, such that the temporary bonding layer is not easy to be removed after application. On the contrary, if the amount of the at least one of the hydrocarbon-based polymer resins is too much (for example, more than 30 wt %), crosslinking density between the material would be increased, thereby masking the linkage structure reacting with the basic solution and affecting the cleaning rate.

The main resin includes at least one resin selected from a group consisting of an epoxy resin, an alkyd resin, a phenol formaldehyde resin, a polyurethane resin and a polyester polyol resin, and the polyester polyol resin is preferable. In some embodiments, when the main resin is the polyester polyol resin, the polyester polyol resin has a molecular weight in a range between 5000 and 50000. Hence, the temporary bonding agent composition can have more suitable complex viscosity, and thus having greater gap-filling ability. In some examples, the main resin can be, for example, the polyester polyol resin produced by Bridge Trading Co., Ltd. with product name of SANNIX KC-229 and molecular weight of 5000; the polyester polyol resin produced by Macroocean with product name of AL148 and molecular weight of 50000; the polyester polyurethane resin produced by An Fong Industrial Co., Ltd. with product name of TPU-2091A; and the polyester polyurethane resin produced by Arakawa Chemical Industries, Ltd. with product name of KL-540R.

Conventionally, increasing rigidity is achieved by using thermosetting resin or acrylic ester and block copolymer of polystyrene, but the conventional method leads to a decrease in the removing rate with the basic solution. Hence, in some embodiments, the at least one of the hydrocarbon-based polymer resins should include a functional group able to react with hydroxyl groups of the main resin to form polyurethane linkage, such that the temporary bonding agent composition is easily to be removed by the basic solution (such as organic basic solution) during subsequent cleaning operation. In the aforementioned embodiments, the functional groups included by the hydrocarbon-based polymer resins are cyanate groups or isocyanate groups. In some examples, the hydrocarbon-based polymer resin with such functional groups can be aliphatic isocyanate resin produced by An Fong Industrial Co., Ltd. with product name of REXIN1973/900 and molecular weight of 50000; or dicyclopentadiene isocyanate resin produced by VAST-WELL Material Development Co., Ltd. with product name of Vast-CE C03C and CAS NO of 135507-71-0.

In some embodiments, the solvent can be at least one of N-methylpyrrolidone (NMP), methyl ethyl ketone (MEK), dibasic ester (DBE) and cyclohexanone (CYC), and a mixing solvent containing the dibasic ester and other solvent is preferable. Since the dibasic ester has properties of multiple boiling points, it can avoid the temporary bonding agent composition bumping at high temperature, and the temporary bonding layer (such as temporary bonding film) formed by the temporary bonding agent composition can have better film properties.

The temporary bonding agent composition of the present disclosure has a heat resistance temperature in a range from about 350° C. to about 405° C., and from about 370° C. to about 405° C. is preferable. It is noted that the aforementioned “heat resistance temperature” refers to T_{d} (5%), representing the temperature at which the temporary bonding agent composition is subjected to thermal decomposition with 5% weight loss. T_{d} (5%) is evaluated by a thermogravimetric analyzer. Compared to the conventional temporary bonding agent, the temporary bonding agent composition of the present disclosure has better heat resistance.

The temporary bonding agent composition of the present disclosure has a complex viscosity less than about 1000 Pa·s at a temperature of 100° C. to 160° C., less than about 900 Pa·s is preferable, and less than about 500 Pa·s is more preferable. It is noted that the general die bonding process heats to a temperature of about 100° C. to about 160° C., so the temporary bonding agent composition having lower complex viscosity at such temperature can have better gap-filling ability. Thus, the temporary bonding agent composition of the present disclosure has great gap-filling ability during application process. Moreover, the temporary bonding agent composition of the present disclosure has a colloidal viscosity in a range between about 2300 cps and about 7000 cps. The temporary bonding layer formed by coating the temporary bonding agent composition with the specific colloidal viscosity can have better film properties and have better flatness.

The temporary bonding agent composition of the present disclosure has a storage modulus in a range from about 5 MPa to about 50.5 MPa at 200° C. after the temporary bonding agent composition is heated at a temperature of 50° C. to 300° C. for over 10 minutes. Preferably, the storage modulus is in a range from about 15 MPa to about 50.5 MPa; more preferably, it is in a range from about 20 MPa to about 50.5 MPa. In the temporary bonding agent composition, the hydrocarbon-based polymer resin that is not reacting with the main resin to form the polyurethane linkage will have a self-crosslinking reaction at high temperature, thereby forming three-dimensional network structure and helping increase rigidity of the material and decrease fluidity of the temporary bonding agent composition at high temperature. In order to avoid grain slip at high temperature, the storage modulus of the temporary bonding agent composition should be at least 5 MPa. In other words, the temporary bonding layer formed by the temporary bonding agent composition of the present disclosure has greater rigidity at high temperature, thereby reducing or avoiding grain slip and popcorn problems.

Since the temporary bonding agent composition of the present disclosure can react to form the polyurethane linkage, it can be dissolved in the basic solution; thus, it can be removed by using the basic solution after the process. In some embodiments, the basic solution includes an organic basic solution, such as at least one of tetramethylammonium hydroxide, tetraethylammonium hydroxide and ethanolamine. In some embodiments, a cleaning rate of the temporary bonding agent composition at a temperature of 60° C. is in a range between about 2 μm/min and about 7.5 μm/min by using the basic solution. The aforementioned cleaning rate range can increase rate of removing the adhesive layer formed from the temporary bonding agent.

The present disclosure further provides a temporary bonding agent solution, which can be coated on a substrate by spin coating to form the temporary bonding layer (such as temporary bonding adhesive). The aforementioned temporary bonding agent solution includes the above temporary bonding agent composition. In some embodiments, the temporary bonding agent solution is obtained by further diluting the temporary bonding agent composition with the solvent, and the dilution ratio can be, for example, about 10% to about 60%. The solvent used for dilution can be the same as the above solvent.

The following Embodiments are provided to better elucidate the practice of the present invention and should not be interpreted in any way as to limit the scope of same. Those skilled in the art will recognize that various modifications may be made while not departing from the spirit and scope of the invention. All publication and patent applications mentioned in the specification are indicative of the level of those skilled in the art to which this invention pertains.

### Embodiment 1

The temporary bonding agent composition of embodiment 1 includes the polyester polyol resin (manufacturer: Macroocean, product name: AL148) as the main resin in 20 wt % and the hydrocarbon-based polymer resin with the isocyanate group (manufacturer: An Fong Industrial Co., Ltd., product name: REXIN1973/900) in 15 wt %, and a mixture of the dibasic ester and the methyl ethyl ketone is used as the solvent. Then, the complex viscosity, the colloidal viscosity, the cleaning rate, the storage modulus and the heat resistance temperature of the temporary bonding agent composition of embodiment 1 are tested, and the test results are shown in following table 1.

### Embodiments 2 to 8 and Comparative Example 1 to 8

Embodiments 2 to 8 and comparative example 1 to 8 use the similar method to prepare the temporary bonding agent composition, so it is not discussed herein. The composition and the test results are shown in following table 1 and table 2.

TABLE 1

| | Embodiment | | | | | | | |
|---|---|---|---|---|---|---|---|---|
| | 1 | 2 | 3 | 4 | 5 | 6 | 7 | 8 |
| main resin | polyester | polyester | polyester | polyester | polyester | polyester | polyurethane | polyurethane |
| | polyol | polyol | polyol | polyol | polyol | polyol | resin | resin |
| | resin | resin | resin | resin | resin | resin | | |
| molecular weight | 50000 | 50000 | 50000 | 50000 | 50000 | 5000 | 5000 | 50000 |
| amount of the | 20 | 20 | 30 | 35 | 35 | 35 | 35 | 35 |
| main resin (wt %) | | | | | | | | |
| functional group | isocyanate | isocyanate | isocyanate | isocyanate | isocyanate | isocyanate | isocyanate | cyanate |
| of the | group | group | group | group | group | group | group | group |
| hydrocarbon- | | | | | | | | |
| based polymer | | | | | | | | |
| resin | | | | | | | | |
| amount of the | 15 | 30 | 22.5 | 15 | 30 | 15 | 15 | 15 |
| hydrocarbon- | | | | | | | | |
| based polymer | | | | | | | | |
| resin (wt %) | | | | | | | | |
| solvent (wt %) | 60 | 55 | 42.5 | 45 | 30 | 45 | 45 | 45 |
| complex viscosity | 832 | 932 | 585 | 432 | 641 | 358 | 464 | 389 |
| (100° C.-160° C., | | | | | | | | |
| Pa · s) | | | | | | | | |
| heat resistance | 360 | 405 | 389 | 352 | 400 | 351 | 375 | 356 |
| temperature | | | | | | | | |
| (T_{d}, 5%, ° C.) | | | | | | | | |
| cleaning rate | 2.7 | 2 | 2.8 | 7.5 | 2.3 | 7.3 | 7.1 | 6.9 |
| (μm/min) | | | | | | | | |
| storage modulus | 5.9 | 50.5 | 30.4 | 5.2 | 50.1 | 5.1 | 5.2 | 5.1 |
| (260° C., MPa) | | | | | | | | |
| colloidal viscosity | 2415 | 5168 | 5245 | 5004 | 6821 | 3189 | 4168 | 4694 |
| (cps) | | | | | | | | |

TABLE 2

| | Comparative example | | | | | | | |
|---|---|---|---|---|---|---|---|---|
| | 1 | 2 | 3 | 4 | 5 | 6 | 7 | 8 |
| main resin | polyester | polyester | polyester | polyester | polyester | polyester | polyurethane | polyurethane |
| | polyol | polyol | polyol | polyol | polyol | polyol | resin | resin |
| | resin | resin | resin | resin | resin | resin | | |
| molecular weight | 50000 | 50000 | 50000 | 50000 | 5000 | 50000 | 50000 | 50000 |
| amount of the | 35 | 20 | 35 | 36 | 36 | 19 | 20 | 35 |
| main resin (wt %) | | | | | | | | |
| functional group | isocyanate | isocyanate | isocyanate | isocyanate | isocyanate | isocyanate | cyanate | cyanate |
| of | group | group | group | group | group | group | group | group |
| thehydrocarbon- | | | | | | | | |
| based polymer | | | | | | | | |
| resin | | | | | | | | |
| amount of the | 14 | 14 | 31 | 30 | 31 | 30 | 14 | 31 |
| hydrocarbon- | | | | | | | | |
| based polymer | | | | | | | | |
| resin (wt %) | | | | | | | | |
| solvent (wt %) | 46 | 61 | 28 | 28 | 27 | 46 | 61 | 28 |
| complex viscosity | 308 | 739 | 908 | 918 | 987 | 1015 | 689 | 915 |
| (100° C.-160° C., | | | | | | | | |
| Pa · s) | | | | | | | | |
| heat resistance | 350 | 357 | 401 | 398 | 403 | 403 | 353 | 389 |
| temperature | | | | | | | | |
| (T_{d}, 5%, ° C.) | | | | | | | | |
| cleaning rate | 8.4 | 5.6 | 1.8 | 2.4 | 1.8 | 2 | 5.3 | 1.6 |
| (μm/min) | | | | | | | | |
| storage modulus | 4.12 | 4.6 | 51.1 | 44.4 | 51.3 | 50.4 | 4.5 | 38.3 |
| (260° C., MPa) | | | | | | | | |
| colloidal viscosity | 4805 | 2304 | 6983 | 7094 | 7231 | 5052 | 2014 | 7153 |
| (cps) | | | | | | | | |

### Test Method

### Heat Resistance Temperature

The heat resistance temperature test is performed by the thermogravimetric analyzer (TGA) (manufacturer: TA, product name: Q-500) to analyze the temporary bonding agent composition heated from room temperature (25° C.) to 500° C. under nitrogen atmosphere, and a heating rate is 20° C. per minute. When weight loss reaches 5%, the decomposition temperature is defined as the heat resistance temperature of the temporary bonding agent composition.

### Cleaning Rate

First, the temporary bonding agent composition is spin-coated on the substrate, which is then heated at a temperature of 130° C. for 20 minutes to remove the solvent. Subsequently, the substrate is put into an oxygen-free oven to be heated at a temperature of 230° C. for 6 hours, and then at a temperature of 260° C. for 2 hours to be cured completely, thereby forming an adhesive layer on the substrate. An initial thickness of the adhesive layer is measured by a thickness gauge, and the substrate with the adhesive layer is dipped into a cleaning liquid, which is an organic solvent including tetramethyl ammonium hydroxide in a concentration of 2.38%. The cleaning rate is defined as time needed to completely remove the adhesive layer on the substrate under condition that the cleaning liquid has a liquid temperature of 60° C.

### Storage Modulus

Elastic properties of the samples are measured by a dynamic mechanical analyzer (DMA) (manufacturer: TA, product name: Q800). The temporary bonding agent composition is blade-coated on a release film, and then is put into an oxygen-free oven to be heated at a temperature of 230° C. for 6 hours, and then at a temperature of 260° C. for 2 hours to be cured completely, thereby obtaining a thin film sample. The cured sample is taken down from the release film, and the final thickness of that is measured. Then, the sample is analyzed by the DMA, and the measurement condition is at room temperature (25° C.) to 300° C., heating rate is 10° C./min, and the strain is 0.1%.

### Complex Viscosity

The lowest complex viscosity of the sample (temporary bonding agent composition) at a temperature of 100° C. to 160° C. is tested. The test method is that the temporary bonding agent composition is blade-coated to prepare a thin film sample, and two identical thin film samples are pasted together (total thickness is over 500 μm) at a temperature greater than a softening temperature of the sample and lower than a crosslinking temperature (160° C.) of the sample, thereby preparing a sample to be measured. Then, the sample to be measured is analyzed by a rheometer (manufacturer: TA, product name: DHR-2), and measurement condition is at room temperature (25° C.) to 250° C., heating rate is 10° C./min, and pressure is 5 N.

### Colloidal Viscosity

The test is performed by a rotational viscometer. The temporary bonding agent composition is temperature set by using a thermostatic water bath at 25° C.±1° C. A rotor with a product name of Z-91 is put into the water bath to rotate, and the colloidal viscosity of the temporary bonding agent composition is measured.

According to above table 1 and table 2, when the amount of the hydrocarbon-based polymer resin is less than 15 wt % (based on the amount of the temporary bonding agent composition as 100 wt %), the temporary bonding agent composition has lower storage modulus (lower than 5 MPa); when the amount of the hydrocarbon-based polymer resin is more than 30 wt %, the cleaning rate of the temporary bonding agent composition is slower (less than 2 μm/min), so it is difficult to be removed by the basic solution. In addition, when the amount of the main resin is more than 35 wt % (based on the amount of the temporary bonding agent composition as 100 wt %), the colloidal viscosity of temporary bonding agent composition is too high, thereby affecting the flatness of the temporary bonding layer obtained after coating; when the amount of the main resin is less than 20 wt %, the complex viscosity of the temporary bonding agent composition is too high, resulting in poor gap-filling ability.

According to the above embodiments, the temporary bonding agent composition and the temporary bonding agent solution of the present disclosure can make the temporary bonding layer with great rigidity formed by the temporary bonding agent, which is obtained by the specific amount of the main resin and the hydrocarbon-based polymer resin, can avoid problems of grain slip and popcorn. Further, the temporary bonding layer has great gap-filling ability at application temperature and can be removed by using basic solution.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A temporary bonding agent composition, comprising:
a main resin, wherein the main resin comprises at least one resin selected from a group consisting of an epoxy resin, an alkyd resin, a phenol formaldehyde resin, a polyurethane resin and a polyester polyol resin; and
hydrocarbon-based polymer resins, wherein at least one of the hydrocarbon-based polymer resins has a functional group able to react with the main resin to form a polyurethane linkage, and based on an amount of the temporary bonding agent composition as 100 wt %, an amount of the main resin is 20 wt % to 35 wt %, and an amount of the at least one of the hydrocarbon-based polymer resins is 15 wt % to 30 wt %.

2. The temporary bonding agent composition of claim 1, wherein when the main resin is the polyester polyol resin, the polyester polyol resin has a molecular weight in a range between 5000 and 50000.

3. The temporary bonding agent composition of claim 1, further comprising:
a solvent, wherein the solvent comprises at least one of N-methylpyrrolidone, methyl ethyl ketone, dibasic ester and cyclohexanone.

4. The temporary bonding agent composition of claim 1, wherein the functional group is a cyanate group or an isocyanate group.

5. The temporary bonding agent composition of claim 1, wherein the temporary bonding agent composition has a heat resistance temperature in a range from 350° C. to 405° C.

6. The temporary bonding agent composition of claim 1, wherein the temporary bonding agent composition has a complex viscosity less than 1000 Pas at a temperature of 100° C. to 160° C.

7. The temporary bonding agent composition of claim 1, wherein the temporary bonding agent composition has a storage modulus in a range from 5 MPa to 50.5 MPa at 200° C. after the temporary bonding agent composition is heated at a temperature of 50° C. to 300° C. for over 10 minutes.

8. The temporary bonding agent composition of claim 1, wherein the temporary bonding agent composition can be dissolved in a basic solution, and the basic solution comprises at least one of tetramethylammonium hydroxide, tetraethylammonium hydroxide and ethanolamine.

9. The temporary bonding agent composition of claim 8, wherein a cleaning rate of the temporary bonding agent composition at a temperature of 60° C. is in a range between 2 μm/min and 7.5 μm/min by using the basic solution.

10. A temporary bonding agent solution, comprising the temporary bonding agent composition of claim 1.

11. A temporary bonding agent composition, comprising:
a main resin, wherein the main resin comprises at least one resin selected from a group consisting of an epoxy resin, an alkyd resin, a phenol formaldehyde resin, a polyurethane resin and a polyester polyol resin; and
hydrocarbon-based polymer resins, wherein at least one of the hydrocarbon-based polymer resins has a cyanate group or an isocyanate group, and a ratio of an amount of the main resin to an amount of the at least one of the hydrocarbon-based polymer resins is 0.67 to 2.33.

12. The temporary bonding agent composition of claim 11, wherein based on an amount of the temporary bonding agent composition as 100 wt %, the amount of the main resin is 20 wt % to 35 wt %, and the amount of the at least one of the hydrocarbon-based polymer resins is 15 wt % to 30 wt %.

13. The temporary bonding agent composition of claim 11, wherein the main resin is the polyester polyol resin.

14. The temporary bonding agent composition of claim 13, wherein the polyester polyol resin has a molecular weight in a range between 5000 and 50000.

15. The temporary bonding agent composition of claim 11, further comprising:
a solvent, wherein the solvent is a mixing solvent comprising dibasic ester and at least one of solvent selected from a group consisting of N-methylpyrrolidone, methyl ethyl ketone and cyclohexanone.

16. The temporary bonding agent composition of claim 13, wherein the temporary bonding agent composition has a colloidal viscosity in a range between 2300 cps and 7000 cps.
